(19) United States
(12) Patent Application Publication
(10) Pub. No.: US 2017/0147929 A1
(43) Pub. Date: May 25, 2017

(54) INFORMATION PROCESSING APPARATUS, INFORMATION PRESENTATION METHOD, AND PROGRAM

(71) Applicant: SONY CORPORATION, TOKYO (JP)

(72) Inventors: TOMOHIRO TSUNODA, TOKYO (JP); MAKOTO SATO, TOKYO (JP)

(21) Appl. No.: 15/308,765

(22) PCT Filed: Mar. 2, 2015
(86) PCT No.: PCT/JP2015/056111

§ 371 Date: Nov. 3, 2016

(30) Foreign Application Priority Data
May 27, 2014 (JP) 2014-109201

(51) Int. Cl. G06N 5/04; G06Q 10/10; G06Q 50/28; G06Q 10/08

(52) U.S. Cl. CPC G06N 5/04; G06Q 10/08355; G06Q 10/109; G06Q 50/28

(57) ABSTRACT

[Object] To provide an information processing apparatus, an information presentation method, and a program capable of providing an item on the basis of a prediction of a user's action. [Solution] Provided is an information processing apparatus including an acquisition unit configured to acquire sensing data obtained by detecting an action of a user, a recognition unit configured to recognize a situation of the user on the basis of the acquired sensing data, an action prediction unit configured to predict an action of the user on the basis of the recognized situation of the user, and a presentation unit configured to present information for providing an item to the user on the basis of the predicted action of the user.

### CROSS REFERENCE TO RELATED APPLICATIONS

This application is a U.S. National Phase of International Patent Application No. PCT/JP2015/056111 filed on Mar. 2, 2015, which claims priority benefit of Japanese Patent Application No. JP 2014-109201 filed in the Japan Patent Office on May 27, 2014. Each of the above-referenced applications is hereby incorporated herein by reference in its entirety.

### TECHNICAL FIELD

The present disclosure relates to information processing apparatuses, information presentation methods, and programs.

### BACKGROUND ART

Logistics management has in recent years been conducted using a network in which a plurality of communication terminals, such as computers and the like, are connected together through communication lines. In such logistics management systems, data related to products which is input at a distribution place where each terminal is provided is input to a database, to perform procedures for management and delivery of products.

For example, Patent Literature 1 described below proposes a logistics information management system in which a logistics communication terminal possessed by a logistics operator, a product handler, or the like, a communication terminal possessed by a sender who ships products, and a communication terminal possessed by a receiver who receives products are connected together, and the communication terminals exchange information such as a transport route, delivery schedule, and the like of products with each other using electronic mail.

Also, a system has been proposed in which products are delivered to a place where a user is currently located, according to the current location of the user which is acquired using the global positioning system (GPS) or the like.

### CITATION LIST

### Patent Literature

Patent Literature 1: JP H10-143568A

### SUMMARY OF INVENTION

### Technical Problem

However, in conventional logistics systems, the control of logistics does not involve the prediction of a user's action such as the time a user will arrive home, the route a user will follow, or the like.

With the above in mind, the present disclosure proposes an information processing apparatus, information presentation method, and program capable of providing an item on the basis of the prediction of a user's action.

### Solution to Problem

According to the present disclosure, there is provided an information processing apparatus including an acquisition unit configured to acquire sensing data obtained by detecting an action of a user, a recognition unit configured to recognize a situation of the user on the basis of the acquired sensing data, an action prediction unit configured to predict an action of the user on the basis of the recognized situation of the user, and a presentation unit configured to present information for providing an item to the user on the basis of the predicted action of the user.

According to the present disclosure, there is provided an information presentation method including acquiring sensing data obtained by detecting an action of a user, recognizing a situation of the user on the basis of the acquired sensing data, predicting an action of the user on the basis of the recognized situation of the user, and presenting information for providing an item to the user on the basis of the predicted action of the user.

According to the present disclosure, there is provided a program for causing a computer to function as an acquisition unit configured to acquire sensing data obtained by detecting an action of a user, a recognition unit configured to recognize a situation of the user on the basis of the acquired sensing data, an action prediction unit configured to predict an action of the user on the basis of the recognized situation of the user, and a presentation unit configured to present information for providing an item to the user on the basis of the predicted action of the user.

### Advantageous Effects of Invention

As described above, according to the present disclosure, an item can be provided on the basis of the prediction of a user's action.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of a delivery system according to one embodiment of the present disclosure.

FIG. 2 is a diagram showing an example of an internal configuration of each of an information provision server and a logistics management server included in a delivery system.

FIG. 3 is a diagram for describing the prediction of a user's action by an action prediction unit according to this embodiment.

FIG. 4 is a sequence diagram showing a data collection process for predicting an action according to this embodiment.

FIG. 5 is a sequence diagram showing an optimization process involved in delivery of a product to a user according to this embodiment.

FIG. 6 is a block diagram showing an example of a hardware configuration of an information processing apparatus which can be implemented as either an information provision server or a logistics management server according to this embodiment.

### DESCRIPTION OF EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Also, description will be provided in the following order.
1. Overview of delivery system according to one embodiment of the present disclosure
2. Basic configuration
2-1. Information provision server
2-2. Logistics management server
3. Operation process
3-1. Data collection process
3-2. Delivery optimization process
4. Conclusion

### 1. OVERVIEW OF DELIVERY SYSTEM ACCORDING TO ONE EMBODIMENT OF THE PRESENT DISCLOSURE

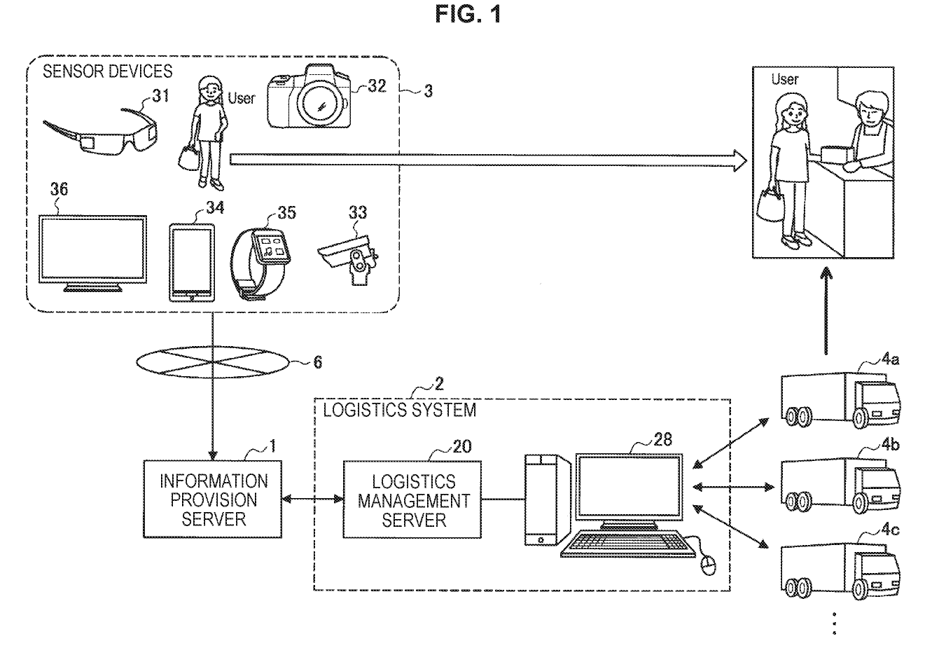

Firstly, an overview of a delivery system according to one embodiment of the present disclosure will be described with reference to FIG. 1. As shown in FIG. 1, the delivery system according to this embodiment includes various sensor devices 3 which detect a user's action, an information provision server 1 which predicts a user's action on the basis of sensing data, and presents information for delivering (providing) a product (an example of an item) to the user, and a logistics system 2 which performs procedures for management and delivery of products.

Examples of the sensor devices 3 include a wearable device which is worn on a user, such as a glasses-type HMD 31, watch-type device 35, or the like, a mobile terminal which is used by a user, such as a digital camera 32, smartphone 34, or the like, a surveillance camera 33 which is installed in a town or building, and the like. Data of the location information, movement speed, and the like of a user which are acquired by the sensor devices 3 are transmitted to the information provision server 1 through a network 6. As a result, the information provision server 1 can acquire a log of the user's actions. Also, the information provision server 1 can correctly determines whether or not a user is home, on the basis of data indicating whether a television device 36 in the user's home is on or off.

The information provision server 1 predicts a user's action on the basis of the user's current location and action log, and optimizes a place and time where and when a product is to be delivered on the route of the predicted action. Thereafter, the information provision server 1 transmits, to a logistics management server 20, information (place and time) for delivering a product to the user.

The logistics system 2 includes the logistics management server 20 and an operator terminal 28. The operator terminal 28 instructs each of delivery vehicles 4a-4c to load and deliver products. Although FIG. 1 shows only one operator terminal 28, this embodiment is not limited to this. A plurality of operator terminals 28 may be connected to the logistics management server 20.

The logistics management server 20 performs procedures for management and delivery of products on the basis of information for delivering products to users which is transmitted from the information provision server 1. Specifically, the logistics management server 20 outputs information about a place and time where and when a product is to be provided, to a corresponding operator terminal 28, and the operator terminal 28 instructs a corresponding delivery vehicle 4 to load and deliver the product. Thereafter, the delivery vehicle 4 delivers the product to the designated place, so that a user can receive the product on their route, such as a station or convenience store on their way home, or the like.

Thus, in the delivery system according to this embodiment, a user's action is predicted in real time, and a product is delivered in advance to an optimum place on their route based on the prediction result so that the product can be provided to the user. Therefore, the user does not need to wait for the arrival of a product at his/her home, and can receive the product on his/her route based on the automatic prediction of the user's action while the user is leading a normal life.

In the foregoing, an overview of the delivery system according to one embodiment of the present disclosure has been described. Next, a basic configuration of this embodiment will be described.

### 2. BASIC CONFIGURATION

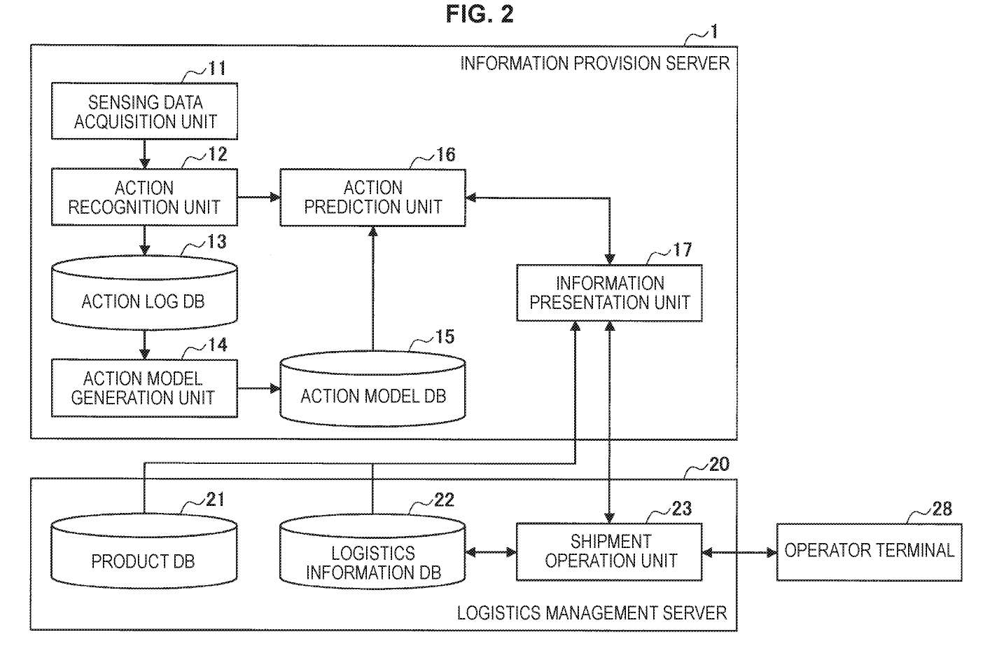

Next, the internal configurations of the information provision server 1 and the logistics management server 20 included in the delivery system according to this embodiment will be described with reference to FIG. 2. FIG. 2 is a diagram showing an example of the internal configuration of each server.

### <2-1. Information Provision Server>

As shown in FIG. 2, the information provision server 1 has a sensing data acquisition unit 11, an action recognition unit 12, an action log DB 13, an action model generation unit 14, an action model DB 15, an action prediction unit 16, and an information presentation unit 17.

The sensing data acquisition unit 11 acquires sensing data obtained by detecting a user's action from the sensor devices 3, and outputs the acquired sensing data to the action recognition unit 12. Here, the sensing data is, for example, location information, acceleration information, captured image data, audio data, or the like of a user.

The action recognition unit 12 recognizes a user's situation on the basis of the sensing data, and stores the recognition result into the action log DB 13. The action recognition unit 12 continually recognizes a user's situation and stores the recognition result into the action log DB 13, in which the user's past logs (a history of action logs) are accumulated. Also, the action recognition unit 12 outputs a user's current situation recognized on the basis of the sensing data, to the action prediction unit 16, in real time.

The action log DB 13 stores a user's situation recognized by the action recognition unit 12. Here, a user's situation includes, for example, a log of the user's movement paths (action log). Also, the action log includes a log of movement means (on foot, by train, car, or bicycle, etc.) which is inferred by the action recognition unit 12 on the basis of information about the movement speed, acceleration, or the like.

The action model generation unit 14 models a user's action on the basis of the user's action logs (past logs) accumulated in the action log DB 13, to generate (construct) an action model which is to be used in action prediction. The action model generation unit 14 stores the generated action model into the action model DB 15. Note that the action model generation unit 14 according to this embodiment may supplement a user's action logs by referring to other users' accumulated action logs (past logs) or other users' action models.

The action model DB 15 accumulates action models for each user. Examples of the accumulated action models include a user's action models in weekdays and holidays each of which indicates the probability that the user moves from one place to another.

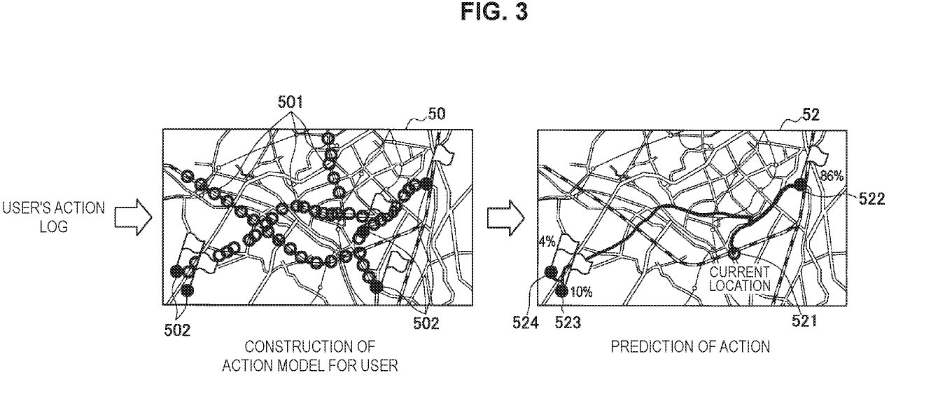

The action prediction unit 16 predicts a user's future action using the user's current situation (e.g., a current location) recognized by the action recognition unit 12 and the user's action models accumulated in the action model DB 15. Also, the action prediction unit 16 can predict a user's future action by utilizing other users' action logs and action models. As a result, the action prediction unit 16 can predict the level of traffic congestion, or a user's action on a route which the user takes for the first time (e.g., people who are on a predetermined route then commonly transfer at a predetermined station, etc.). Here, the action prediction performed by the action prediction unit 16 will be described with reference to FIG. 3.

As shown in FIG. 3, the action prediction unit 16 predicts a user's action using a user's action model 50 constructed on the basis of the user's action log, and outputs an action prediction result 52. Specifically, in the user's action model 50 shown in a middle portion of FIG. 3, shown are a plurality of nonstop point candidates 501 each having the probability that a user moves from one place to another, and stop point candidates (candidate places which are a destination, such as home, an office, or a station) 502 where a user is highly likely to stay. The action prediction unit 16 predicts a user's action on the basis of the user's action model 50 and the user's current location (starting point) recognized by the action recognition unit 12, and calculates candidates for the destination (finishing point).

An action prediction result 52 shown in a right portion of FIG. 3 shows that the possibility that the user's destination is a first destination candidate 522 is 86%, the possibility that the user's destination is a second destination candidate 523 is 10%, and the possibility that the user's destination is a third destination candidate 524 is 4%. Also, a route from the current location to each of the destination candidates 522-524 is predicted and shown. Also, the time when the user will arrive at each of the destination candidates 522-524, or the time when the user will pass a certain midpoint, may be predicted.

The action prediction unit 16 outputs such an action prediction result 52 to the information presentation unit 17. Note that the action model and action prediction result shown in FIG. 3 are merely illustrative, and the action model and action prediction result of this embodiment are not limited to these.

The information presentation unit 17 presents information for providing a product to a user to the logistics management server 20 on the basis of an action prediction result output by the action prediction unit 16. Specifically, the information presentation unit 17 optimizes a place and time where and when a product is to be delivered to a user on the route of a predicted user's action. For example, the information presentation unit 17 determines which portion of the route and what time are most suitable for pickup of a product, taking into account a predicted route from a current location to a destination, and predicted passing times. Thereafter, the information presentation unit 17 transmits, to the logistics management server 20, information about the optimum place and time for providing a product to the user.

Alternatively, the information presentation unit 17 according to this embodiment may determine an optimum place and time for providing a product to a user by referring to at least one of product information and logistics information acquired from the logistics management server 20. Specifically, for example, an optimum place for providing a product varies depending on the weight, size, number, etc. of products. As an example, when products are heavy or the number of products is large, the information presentation unit 17 may determine that it is most appropriate to deliver products to a user's home at the time when the user has arrived home, and determine that the place where products are to be provided is the user's home, and the time when products are to be provided is the time when the user will arrive home. Also, the information presentation unit 17 may optimize the place and time where a product is to be delivered, by referring to the logistics information and then taking into consideration the current logistics situation (whether or not the product has already been shipped, etc.) of the product of interest, conditions for reception that are desired by a user (a desire to receive at a station, a desire to receive at a station on the way home, etc.).

Also, the information presentation unit 17 according to this embodiment may optimize the place and time where and time a product is to be delivered, by additionally referring to a user's situation recognized by the action recognition unit 12. Specifically, the action recognition unit 12 may recognize whether a user is alone or along with other people, or whether a user is about to go home or somewhere other than home, on the basis of the user's schedule information or the like, and the information presentation unit 17 determines an optimum place and time for delivery, additionally taking the user's situation into account. For example, when the user is along with other people, or the user is about to go somewhere other than home, it is considered that it is not appropriate to provide a product on a route. In this case, the information presentation unit 17 cancels provision of a product on a route, and optimizes delivery after the user has become alone or it has been predicted that the user will go home, for example.

### <2-2. Logistics Management Server>

Next, the configuration of the logistics management server 20 will be described with reference to FIG. 2. As shown in FIG. 2, the logistics management server 20 has a product DB 21, a logistics information DB 22, and a shipment operation unit 23.

The product DB 21 is a database which stores information about products to be delivered. For example, the product DB 21 stores a trade name, a product code, weight, size, a transport temperature zone, quantity, sender information, receiver information, pre-delivery preparation time information, and the like.

The logistics information DB 22 is a database which stores information about logistics. For example, the logistics information DB 22 stores stock information, shipment information, availability information, desired conditions for reception, and the like.

The shipment operation unit 23 instructs a suitable operator terminal 28 to deliver a product of interest, on the basis of information about the optimized place and time for delivery which have been transmitted from the information provision server 1. Also, the shipment operation unit 23 may update the logistics information DB 22 on the basis of latest delivery information transmitted from the operator terminal 28.

### 3. OPERATION PROCESS

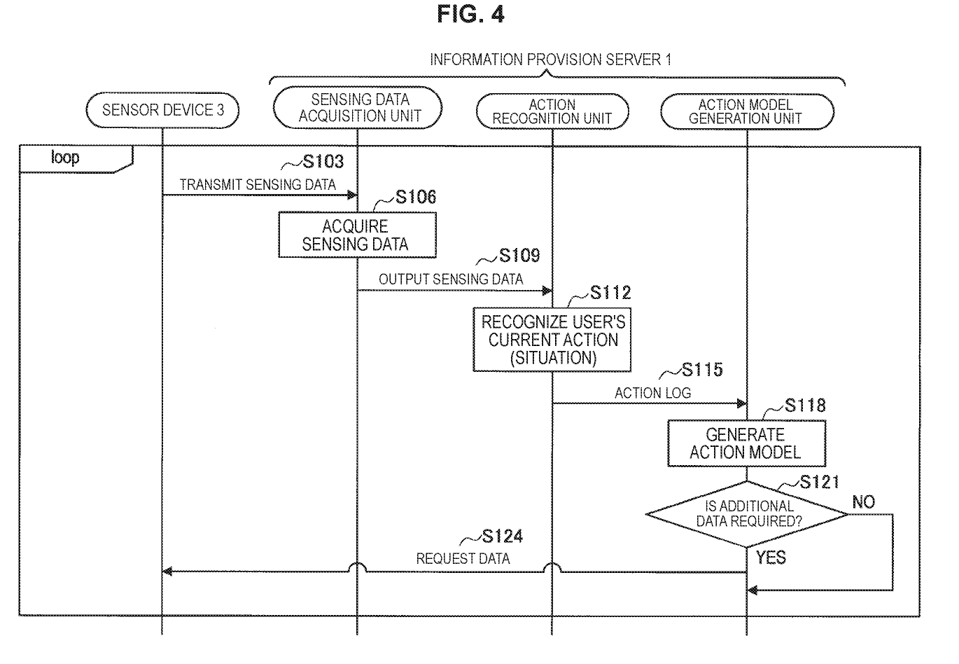

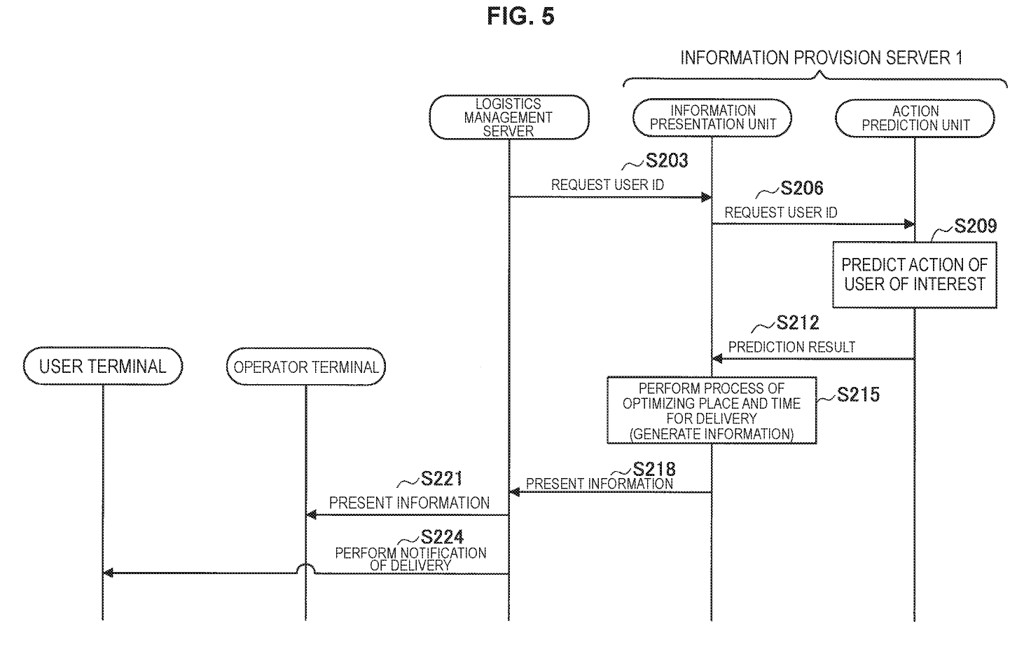

In the foregoing, the configurations of the information provision server 1 and the logistics management server 20 included in the delivery system according to this embodiment have been specifically described. Next, operation processes of the delivery system according to this embodiment will be described with reference to FIG. 4 and FIG. 5.

### <3-1. Data Collection Process>

FIG. 4 is a sequence diagram showing a data collection process of the delivery system according to this embodiment. As shown in FIG. 4, initially, in step S103, the sensor devices 3 transmit sensing data obtained by detecting a user's action to the information provision server 1.

Next, in step S106, the sensing data acquisition unit 11 of the information provision server 1 receives (acquires) the sensing data transmitted from the sensor devices 3, and then in step S109, outputs the sensing data to the action recognition unit 12.

Next, in step S112, the action recognition unit 12 recognizes the user's current action (situation) on the basis of the sensing data acquired by the sensing data acquisition unit 11, and then in step S115, outputs the recognition result as an action log to the action model generation unit 14.

Next, in step S118, the action model generation unit 14 generates an action model for the user on the basis of the user's action log recognized by the action recognition unit 12 (more specifically, a log of actions which have been recognized by the action recognition unit 12 and then accumulated in the action model DB 15). The generated action model is stored into the action model DB 15.

Next, when, in step S121, additional data is required during generation of an action model (S121/Yes), then, in step S124, the action model generation unit 14 requests sensing data from a sensor device 3 of interest. For example, current location information is acquired from the watch-type device 35 worn on the user through the GPS. When the current location information indicates an area around the user's home, the action model generation unit 14 requests detection information indicating whether the television device 36 placed in the user's home is on or off, from the television device 36, and thereby more correctly determines whether or not the user is home.

By continually repeating the above steps S103-S124, the information provision server 1 can collect a large quantity of a user's action log, and generate an action model for the user on the basis of the action log. The action model thus generated is utilized during the prediction of a user's action in a delivery optimization process described below.

### <3-2. Delivery Optimization Process>

FIG. 4 is a sequence diagram showing a delivery optimization process of the delivery system according to this embodiment. As shown in FIG. 4, initially, in step S203, the logistics management server 20 requests optimum delivery information from the information provision server 1, using the ID of a user who is a receiver of a product to be delivered.

Next, in step S206, the information presentation unit 17 of the information provision server 1 requests the action prediction unit 16 to predict the action of the user of interest, using a user ID, in response to the request from the logistics management server 20.

Next, in step S209, the action prediction unit 16 predicts the action of the user corresponding to the user ID which is requested by the information presentation unit 17. Specifically, the action prediction unit 16 predicts the user's action on the basis of the action model for the user of interest extracted from the action model DB 15, and a current user situation (specifically, a current location) of the user of interest recognized by the action recognition unit 12.

Next, in step S212, the action prediction unit 16 outputs the prediction result to the information presentation unit 17.

Next, in step S215, the information presentation unit 17 performs the process of optimizing (determining) a place and time where and when a product is to be delivered, on the basis of the result of the prediction of the user's action, and generates information about the optimum delivery place and delivery time.

Next, in step S218, the information presentation unit 17 presents (transmits) the information indicating the optimum place and time to the logistics management server 20.

Thereafter, in step S221, the logistics management server 20 presents (transmits) the information indicating the optimum place and time to an operator terminal 28. As a result, the operator terminal 28 instructs a predetermined delivery vehicle 4 to, for example, load and ship a product of interest so that the product is to be delivered to the designated place at the designated time, whereby the product of interest can be delivered in advance to a predetermined place on the user's route.

Also, in step S224, the logistics management server 20 notifies a user terminal (a smartphone, mobile telephone, tablet terminal, watch-type device, glasses-type HMD, etc.) possessed by a user of interest of delivery. Specifically, the logistics management server 20 notifies a user that a product is to be delivered to a predetermined place on a predicted route, and thereby prompts the user to receive the product. Note that, in order to more effectively prompt a user to receive a product, the logistics management server 20 may additionally notify the user that if the user receives a product at a predetermined place, the user will be given a discount or points.

As described above, a product is delivered in advance to a predetermined optimum place on a user's route on the basis of the prediction of the user's action. As a result, a product can be more reliably received by a user, and the probability that efforts such as redelivery and the like occur is reduced.

(Information Processing Apparatus According to this Embodiment)

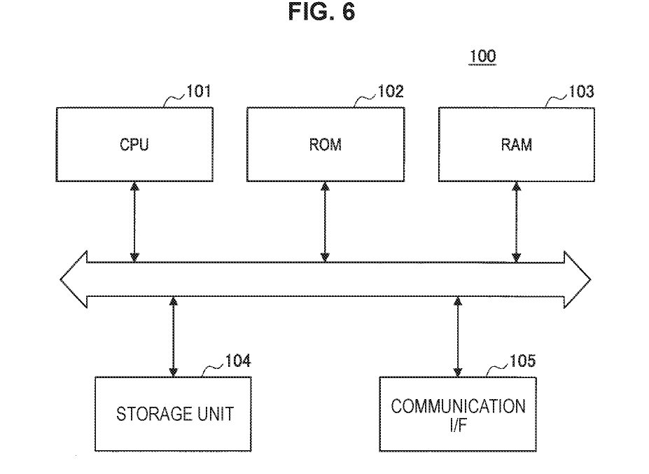

Here, hardware configurations of the information provision server 1 and the logistics management server 20 which perform the above data collection process and delivery optimization process according to this embodiment will be described with reference to FIG. 6. FIG. 6 shows an example of a hardware configuration of an information processing apparatus 100 which can be implemented as either the information provision server 1 or the logistics management server 20.

As shown in FIG. 6, the information processing apparatus 100 has, for example, a central processing unit (CPU) 101, a read only memory (ROM) 102, a random access memory (RAM) 103, a storage unit 104, and an communication interface (I/F) 105. Also, the components of the information processing apparatus 100 are connected together through, for example, a bus which serves as a data transmission path.

The CPU 101, which includes, for example, a microcomputer, controls the components of the information processing apparatus 100. Also, the CPU 101 functions as the action recognition unit 12, the action model generation unit 14, the action prediction unit 16, and the information presentation unit 17 in the information provision server 1. Also, the CPU 101 functions as the shipment operation unit 23 in the logistics management server 20.

The ROM 102 stores, for example, control data such as programs, calculation parameters, and the like which are used by the CPU 101. The RAM 103 temporarily stores, for example, a program executed by the CPU 101.

The storage unit 104 stores various items of data. For example, the storage unit 104 serves as the action log DB 13 and the action model DB 15 in the information provision server 1. Also, the storage unit 104 serves as the product DB 21 and the logistics information DB 22 in the logistics management server 20.

The communication I/F 105, which is a communication means included in the information processing apparatus 100, communicates with an external apparatus included in the delivery system according to this embodiment, through a network (or directly). For example, the communication I/F 105 transmits and receives data to and from the sensor devices 3 through the network 6, and transmits and receives data to and from the logistics management server 20 directly or through the network 6, in the information provision server 1. Also, specifically, the communication I/F 105 may function as the sensing data acquisition unit 11 (receiver) and the information presentation unit 17 (transmitter) in the information provision server 1.

In the foregoing, a hardware configuration of the information processing apparatus 100 according to this embodiment has been described. The configuration of the information processing apparatus 100 is not limited to that which is shown in FIG. 6.

### 4. CONCLUSION

As described above, in a delivery system according to an embodiment of the present disclosure, a product is delivered in advance to an optimum predetermined place on a user's route on the basis of the prediction of the user's action. As a result, a product can be more reliably received by a user, and the probability that efforts such as redelivery and the like occur is reduced.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, a computer program can be provided which causes hardware including a CPU, ROM, RAM, and the like included in the above information provision server 1 and logistics management server 20 to provide the functions of the information provision server 1 and the logistics management server 20. Also, a computer readable storage medium storing the computer program is also provided.

Also, in the delivery system according to this embodiment, in order to optimize places where products are delivered to users, the problem of how a plurality of items (products) are delivered, which is the traveling salesman problem, can be solved, additionally taking the logistics status of each item into account.

Also, the configuration of each server shown in FIG. 2 is merely illustrative, and the delivery system according to this embodiment is not limited to the configurations. For example, the information presentation unit 17 may be provided in the logistics management server 20.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.
(1)

An information processing apparatus including:

an acquisition unit configured to acquire sensing data obtained by detecting an action of a user;

a recognition unit configured to recognize a situation of the user on the basis of the acquired sensing data;

an action prediction unit configured to predict an action of the user on the basis of the recognized situation of the user; and

a presentation unit configured to present information for providing an item to the user on the basis of the predicted action of the user.
(2)

The information processing apparatus according to (1),

wherein the information for providing an item to the user is information indicating where and when the item is to be provided to the user on a route of the predicted action of the user.
(3)

The information processing apparatus according to (1) or (2),

wherein the action prediction unit predicts the action of the user using an action model for the user which is generated on the basis of a past log of the user.
(4)

The information processing apparatus according to (3),

wherein the action model for the user is generated by additionally referring to an action model for another user.
(5)

The information processing apparatus according to any one of (1) to (4),

wherein the presentation unit determines where the item is to be provided, additionally taking properties of the item into account.
(6)

The information processing apparatus according to any one of (1) to (5),

wherein the presentation unit determines where the item is to be provided, on the basis of a current situation of the user.
(7)

The information processing apparatus according to any one of (1) to (6),

wherein the presentation unit determines where the item is to be provided, on the basis of a schedule of the user.
(8)

The information processing apparatus according to any one of (1) to (7),

wherein the item is a product, and

wherein the presentation unit presents information for delivering the product to the user, on the basis of the predicted action of the user and a logistics status of the product.
(9)

An information presentation method including:

acquiring sensing data obtained by detecting an action of a user;

recognizing a situation of the user on the basis of the acquired sensing data;

predicting an action of the user on the basis of the recognized situation of the user; and

presenting information for providing an item to the user on the basis of the predicted action of the user.
(10)

A program for causing a computer to function as:

an acquisition unit configured to acquire sensing data obtained by detecting an action of a user;

a recognition unit configured to recognize a situation of the user on the basis of the acquired sensing data;

an action prediction unit configured to predict an action of the user on the basis of the recognized situation of the user; and

a presentation unit configured to present information for providing an item to the user on the basis of the predicted action of the user.

### REFERENCE SIGNS LIST

1 information provision server
11 sensing data acquisition unit
12 action recognition unit
13 action log DB
14 action model generation unit
15 action model DB
16 action prediction unit
17 information presentation unit
2 logistics system
20 logistics management server
21 product DB
22 logistics information DB
23 shipment operation unit
28 operator terminal
3 sensor device
31 glasses-type HMD
32 digital camera
33 surveillance camera
34 smartphone
35 watch-type device
36 television device
4a-4c delivery vehicle
6 network
50 user's action model
52 action prediction result

1. An information processing apparatus comprising:
an acquisition unit configured to acquire sensing data obtained by detecting an action of a user;
a recognition unit configured to recognize a situation of the user on the basis of the acquired sensing data;
an action prediction unit configured to predict an action of the user on the basis of the recognized situation of the user; and
a presentation unit configured to present information for providing an item to the user on the basis of the predicted action of the user.

2. The information processing apparatus according to claim 1,
wherein the information for providing an item to the user is information indicating where and when the item is to be provided to the user on a route of the predicted action of the user.

3. The information processing apparatus according to claim 1,
wherein the action prediction unit predicts the action of the user using an action model for the user which is generated on the basis of a past log of the user.

4. The information processing apparatus according to claim 3,
wherein the action model for the user is generated by additionally referring to an action model for another user.

5. The information processing apparatus according to claim 1,
wherein the presentation unit determines where the item is to be provided, additionally taking properties of the item into account.

6. The information processing apparatus according to claim 1,
wherein the presentation unit determines where the item is to be provided, on the basis of a current situation of the user.

7. The information processing apparatus according to claim 1,
wherein the presentation unit determines where the item is to be provided, on the basis of a schedule of the user.

8. The information processing apparatus according to claim 1,
wherein the item is a product, and
wherein the presentation unit presents information for delivering the product to the user, on the basis of the predicted action of the user and a logistics status of the product.

9. An information presentation method comprising:
acquiring sensing data obtained by detecting an action of a user;
recognizing a situation of the user on the basis of the acquired sensing data;
predicting an action of the user on the basis of the recognized situation of the user; and
presenting information for providing an item to the user on the basis of the predicted action of the user.

10. A program for causing a computer to function as:
an acquisition unit configured to acquire sensing data obtained by detecting an action of a user;
a recognition unit configured to recognize a situation of the user on the basis of the acquired sensing data;
an action prediction unit configured to predict an action of the user on the basis of the recognized situation of the user; and
a presentation unit configured to present information for providing an item to the user on the basis of the predicted action of the user.
